(19) United States
(12) Patent Application Publication
(10) Pub. No.: US 2005/0045742 A1
(43) Pub. Date: Mar. 3, 2005

(54) Spray

(76) Inventor: Jun Nakamura, Yokohama (JP)

Correspondence Address: THE ESTEE LAUDER COS, INC, 125 PINELAWN ROAD, MELVILLE, NY, 11747, US

(21) Appl. No.: 10/497,368

(22) PCT Filed: Dec. 26, 2002
(86) PCT No.: PCT/JP02/13583

(30) Foreign Application Priority Data
Dec. 26, 2001 (JP) 2001-393168

(51) Int. Cl. B05B 9/043

(52) U.S. Cl. 239/333

(57) ABSTRACT

The spray comprises a spray nozzle for spraying the liquid in the form of a mist, a bottle filled with the liquid, and a conduit through which the liquid flows from the bottle to the spray nozzle. Tourmaline ore particles having particle sizes from 0.1 mm to 5 mm are provided at least at a part of the conduit so that ambient atmosphere is ionized negatively as the liquid passed through the Tourmaline ore is sprayed from the spray nozzle.

### TECHNICAL FIELD OF THE INVENTION

The invention relates to a spray for spraying liquid into the air.

### BACKGROUND OF THE INVENTION

Recently, an effect of negative ions on health is reported in many studies such as “A study on amenity for human in a negative ion atmosphere”, University of Nigata and Corona Inc., collected papers of 11th Lecture of Bio-Engineering Section of Japanese Mechanical Engineering Academy, pp.124-125, March 1993, and “The effect of negative ions on the activity of central and autonomic nerves”, Kyushu Institute of Design, University of Chiba and others, abstract of 39th Congress of Japanese Physiology and Anthropology Academy, p.60, June 1998. Air cleaners with negative ions generating function are also put in practical use. Note that “negative ions” are particulates bearing negative electrical charges, and “negatively ionized air” represents a condition in which many particulates bearing negative electrical charges are suspended in the air.

Generally, a negative ion generator used in an air cleaner applies a high voltage to electrodes to cause an electrostatic discharge. The electrostatic discharge negatively ionize the air. The negative ion generator, however, is not easy to handled since it includes components applied with high voltage and since it requires an external power supply.

It is also known that liquid sprayed into the air ionizes the ambient air negatively (Lenard's effect). However, the amount of negative ions that can be generated by Lenard's effect is small, e.g., only several thousand counts per cm³.

Thus, there has been a demand for a spray that generates a large quantity of negative ions without utilizing the conventional negative ion generator.

### BRIEF DESCRIPTION OF THE INVENTION

According to an aspect of the invention, there is provided a spray that includes a spray nozzle for spraying liquid in the form of a mist, a bottle filled with the liquid, and a conduit through which the liquid flows from the bottle to the spray nozzle. A specific material is provided at least at a part of the conduit such that the liquid passes by the material as it flows toward the spray nozzle. The specific material changes the property of the liquid so that the ionization of the atmosphere as the liquid is sprayed into the atmosphere is enhanced. Thus, the spray configured as above generates a large quantity of negative ions without utilizing the conventional negative ion generator, or any power sources and electrodes to be applied with high voltage.

In some cases, the specific material is held in a material holder which is provided at least at a part of the conduit. The material holder may be a cartridge provided at midway of the conduit and having a hollow portion in which the specific material is to be held. The cartridge may be detachably coupled to the conduit to facilitate the exchange of the specific material.

The specific material to be accommodated in the material holder may be comminuted into small particles having sizes ranging from 0.1 mm to 5 mm, and more preferably, from 0.5 mm to 1 mm so that the specific material comes into contact with the liquid effectively.

Optionally a first filter may be provided at least on a downstream side of the cartridge. Further optionally, a second filter may be provided on an upstream side of the cartridge. The first filter prevents the comminuted specific material from moving into the spray nozzle while the second filter prevents the comminuted specific material from flowing back into the bottle. Both of the first and second filters may be sponges made of polyethylene.

Materials that charge ambient materials, such as water and small particles in the air, by the effect of temperature and/or pressure variations may be used as the specific material. Materials that are permanently polarized such as Tourmaline ore and ceramics containing Tourmaline ore are examples of such specific material.

Material that emits far infrared radiation at ordinary temperature may also be used as the specific material. Examples of such materials include charcoal, Maifan stone, or Serpentine stone, or ceramics containing one or more of them. When liquid is irradiated with far infrared radiation, the cluster of the water in the liquid (which is a plurality of molecules connected together by hydrogen bonding and/or weak forces such as Van der Waals force) will be separated and thus the particle size of the sprayed liquid tends to decrease. Generally, the smaller the particles of the sprayed liquid are, the more the ambient atmosphere is ionized when liquid is sprayed in the atmosphere.

Materials that emit minute quantities of radioactive rays may also be used as the specific material. Examples of such materials include radium-containing ore, and ceramics including radium-containing ore. The water is ionized by the ionization effect of the radioactive rays and thus the liquid including such ionized water ionizes in turn the ambient atmosphere when it is sprayed.

### BRIEF DESCRIPTION OF DRAWINGS

FIG. 1 shows a spray according to an embodiment of the invention; and

FIGS. 2 and 3 show enlarged views of a main part of the spray shown in FIG. 1.

### DESCRIPTION OF THE EMBODIMENTS

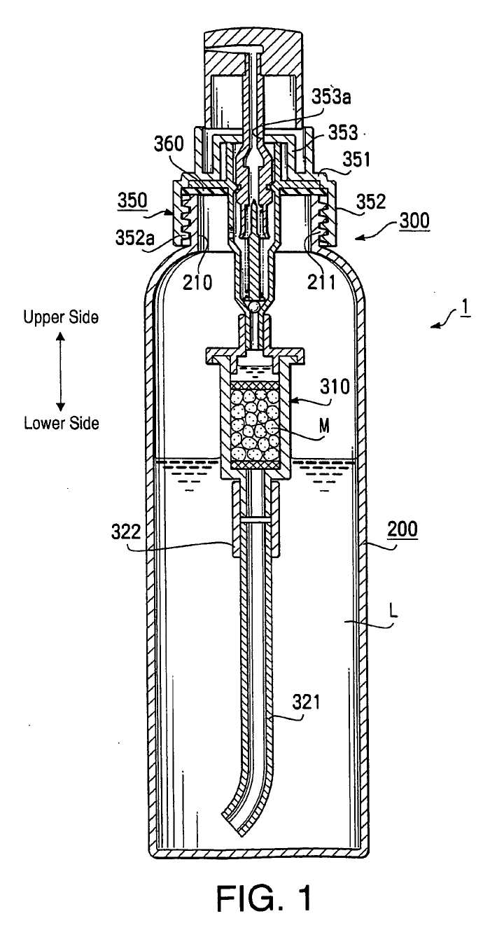

Hereinafter, a spray according to an embodiment of the invention will be described with reference to FIGS. 1 through 3.

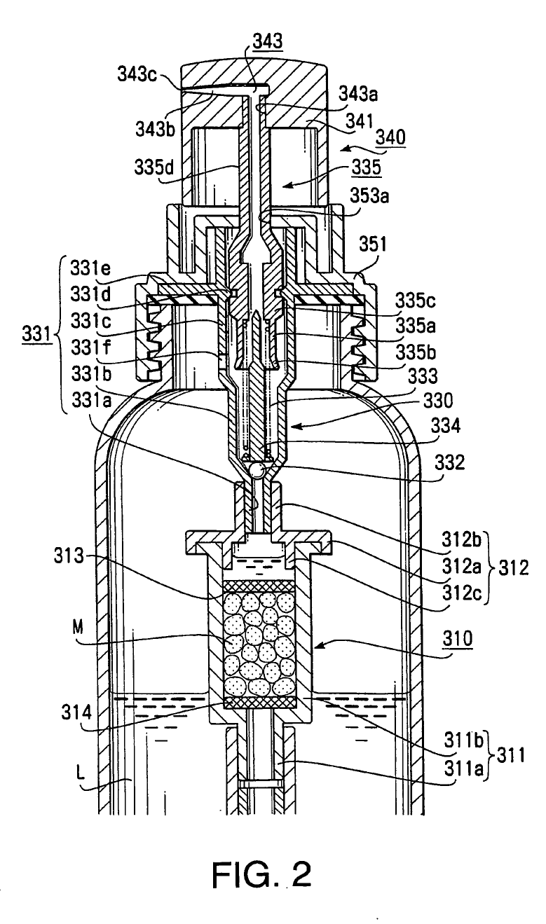

FIG. 1 shows a spray 1 in accordance with an embodiment of the invention, and FIG. 2 shows an enlarged view of a main part of the spray 1 shown in FIG. 1. The spray 1 has a bottle 200 and a spray head 300. The bottle 200 is a cylindrical container with an opening formed at one end thereof. The bottle 200 is filled with liquid L of which solvent is water. An external thread 211 is formed on the outer periphery of the open end 210 of the bottle 200.

Hereinafter, the splay head side of the spray 1 will be referred to as an “upper side” of the spray 1, and the bottom side of the bottle 200 as a “lower side”.

Note that the configuration of the spray 1 is not limited to that shown in FIG. 1, but can be modified into other forms, such as an inclined one, for example, as far as air can be introduced into the bottle 200 to spray the liquid L of the bottle as will be described latter.

The spray head 300 includes a filter cartridge 310, a liquid introducing tube 321, a piston unit 330, a spray nozzle 340, and a cap 350.

The filter cartridge 310 is a hollow cylindrical member having a cartridge body 311 and a cartridge cap 312. The cartridge body 311 has a large diameter cylindrical portion 311b and a small diameter cylindrical portion (pipe) 311a extending from the lower side end of the large diameter cylindrical portion 311b. A flange portion is formed at the upper side end of the large diameter cylindrical portion 311b.

The cartridge cap 312 has a small diameter cylindrical portion (pipe) 312b. A flange portion 312a is formed at the lower side end of the small diameter cylindrical portion 312b. Further, a large diameter cylindrical portion 312c extends from the flange portion 312b.

The small diameter cylindrical portion 311a of the cartridge body 311 is formed such that its outer diameter is substantially the same as that of the liquid introducing tube 321 and also such that its outer diameter is slightly larger than the inner diameter of a cylindrical connecting tube 322. By fitting the small diameter cylindrical portion 311a and the liquid introducing tube 321 into the connecting tube 322 from both sides, the small diameter cylindrical portion 311a and the liquid introducing tube 321 are connected to each other in a leakproof manner.

The cartridge body 311 is filled with the filler M. In the present embodiment, the filler M is comminuted Tourmaline having size of about 0.5-1.0 mm in diameter. It is known that Tourmaline charges ambient materials such as water or small particles in the air. In particular, Tourmaline effectively charges ambient materials if there are temperature and/or pressure variations.

An upper filter 313 and a lower filter 314, both of which have a disc like shape, is located within the large diameter cylindrical portion 311b of the filter cartridge 310, the former at the downstream side of the cartridge body 311 and the later at the upstream side. The filler M is sandwiched between the upper filter 313 and the lower filter 314 to prevent dropping out from the filter cartridge 310. Both upper and lower filters 313, 314 are sponges made of polyethylene having a mesh size much smaller than the particle size of the filler M so that only liquid L passes through the filter cartridge 310.

Though the particle size of the filler M is about 0.5-1 mm in the present embodiment, this should not be considered to limit the invention. Fillers of a variety of particle sizes may be utilized depending on the size and design of each components of the spray and also the property of the filler M.

The large diameter cylindrical portion 312c of the cartridge cap 312 has an outer diameter slightly larger than the inner diameter of the large diameter cylindrical portion 311b of the cartridge body 311. The cartridge cap 312 is connected to the cartridge body 311 in a leakproof manner by fitting the large diameter cylindrical portion 312c of the cartridge cap 312 into the large diameter cylindrical portion 311b of the cartridge body 311.

The piston unit 330 includes a cylinder 331, a metal ball 332, a metal ball stop 334, a spring 333, and a piston 335.

The cylinder 331 is a stepped cylindrical member in which a small diameter portion 331a, a middle diameter portion 331b and a large diameter portion 331c are connected in this order. A flange portion 331e extends from the middle of the large diameter portion 331c. An air hole 331f is formed to the side wall of the large diameter portion 331c of the cylinder 331.

The small diameter portion 331a is formed such that its outer diameter is slightly larger than the inner diameter of the small diameter cylindrical portion 312b of the cartridge cap 312. The cylinder 331 and the cartridge cap 312 are connected in a leakproof manner by fitting the small diameter portion 331a of the cylinder 331 into the small diameter cylindrical portion 312b of the cartridge cap 312.

The piston 335 is inserted slidably into the cylinder 331 from the upper side, that is, from the large diameter portion side. The piston 335 includes a piston body 335c which slides within the large diameter portion 331c of the cylinder 331, a skirt portion 335a which is a cylindrical portion extending downwards from the piston body 335c, and a pipe portion 335d which is a cylindrical portion extending upwards from the piston body 335c. A conduit is formed within the piston 334, which extends from the lower end of the skirt portion 335a to the upper end of the pipe portion 335d.

The inner periphery of the large diameter portion 331c of the cylinder 331 has a narrow diameter portion 331d with which the piston body 335c makes slidable contact.

The lower end of the skirt portion 335a of the piston 335 is formed as a tapered tube 335b of which diameter increases toward the lower end thereof. The diameter of the tapered tube 335b at the lower end thereof is slightly larger than the inner diameter of the middle diameter portion 331b of the cylinder 331 while the outer diameter of the other part of the skirt portion 335a is smaller. If the piston 335 is pushed down within the cylinder 331, the lower end of the tapered tube 335b comes into contact with the middle diameter portion 331b of the cylinder 331. If the piston 335 is further pushed down, then the tapered tube 335b deforms so that the lower end of the tapered tube 335b fits in the middle diameter portion 331b of the cylinder 331 and comes into intimate contact with the inner periphery of the middle diameter portion 331b.

The spring 333 is inserted into the skirt portion 335a from the lower side thereof. The upper end of the spring 333 abuts against the lower end of the piston body 335c of the piston 335. The metal ball stop 334 having a rod like shape is inserted into the spring 333 from the lower side thereof. When the piston 335 is inserted into the cylinder 331, the spring 335 is compressed and urges the metal ball stop 334 downward. As a result, the metal ball stop 334 pushes down the metal ball 332 placed therebelow. The metal ball 332 is made of stainless steel and have a diameter larger than the inner diameter of the small diameter portion 331a of the cylinder 331. Accordingly, the metal ball 332 biased by the metal ball stop 334 functions as a kind of check valve that prevents the liquid L and the air from flowing back from the cylinder 331 into the filter cartridge 310 through the small diameter portion 331c.

The cap 350 is substantially a cylindrical member having a large diameter portion 352, a small diameter portion 353, and a stepped portion 351. The upper end of the small diameter portion 353 is provided with a wall having an opening 353a at substantially the center thereof.

When the cylinder 331, with the piston 335 attached thereto, is inserted into the cap 350 from the large diameter portion 352, the stepped portion 351 of the cap 350 abuts against the upper surface of the flange portion 331e of the cylinder 331, and the pipe portion 335d of the piston 335 protrudes from the cap 350 through the opening 353a. An internal thread 352a is formed to the inner periphery of the large diameter portion 352 of the cap 350. The external thread 211 of the bottle is screwed into the internal thread 352a so that the flange portion 331e of the cylinder 331 is sandwiched between the open end 210 of the bottle 200 and the stepped portion 351 of the cap 350. In this way, the cylinder 331 is secured to the bottle 200. A packing 360 is provided between the upper end of the open end 210 of the bottle 200 and the flange portion 331e of the cylinder 331 to prevent the liquid L from leaking through a clearance between the cylinder 331 and the flange portion 331e.

The spray nozzle 340 has a cylindrical shape with an opening formed at one end thereof. The spray nozzle 340 is attached to the upper end of the pipe portion 335d of the piston 335 with its open end directed downwards. An L shaped liquid passage 343 is formed in the upper portion 341 of the spray nozzle 340. The inlet and outlet of the liquid passage 343 are formed at the inner wall and the outer side wall of the spray nozzle 340, respectively. The upstream side 343a of the liquid passage 343 of the spray nozzle 340 extends upwards from the inner wall of the upper portion 341 of the spray nozzle 340 into the interior of the upper portion 341, and the downstream side 343b of the liquid passage 343 extends horizontally from the interior of the upper portion 341 to the outer side wall of the spray nozzle 340. The upper end of the pipe portion 335d of the piston 335 fits into the upstream side 343a of the liquid passage 343 in a leakproof manner.

Near the outlet of the downstream side 343b (that is, near the outer side wall of the spray nozzle 340), the liquid passage 343 is formed as a tapered tube 343c of which diameter gradually decreases toward the outlet.

Now, the operation of the spray 1 configured as above will be described.

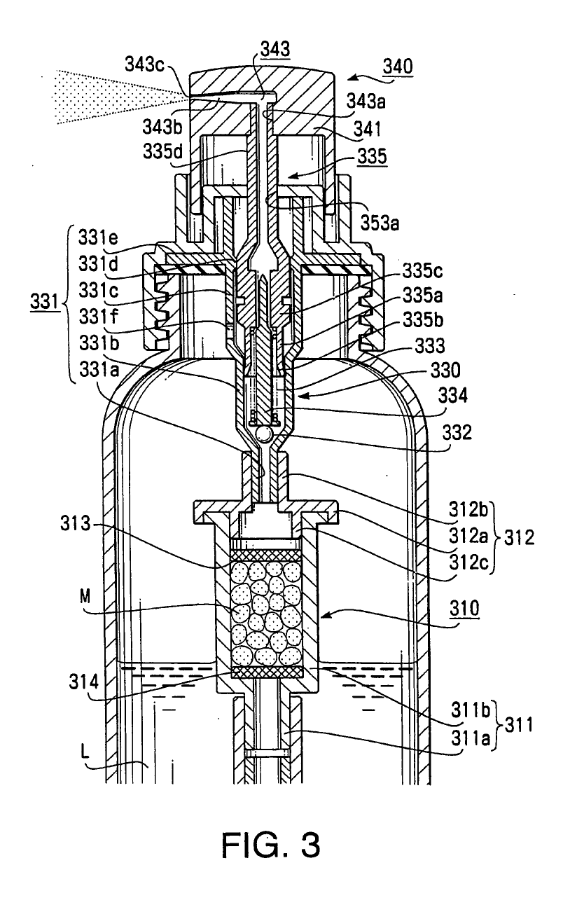

FIG. 3 shows the spray 1 with the spray nozzle 340 being pushed down to spray liquid L. When the spray nozzle 340 is pushed down, the piston 335 moves down within the cylinder 331 and caused the air inside the cylinder 331 to be discharged into the bottle 200 through the air hole 331f.

As a result, the pressure of the air inside the bottle 200 increases and pushes down the liquid L. The liquid L pushed down by the air flows through the liquid introducing tube 321 and the filter cartridge 310 and then pushes up the metal ball 332 that is biased downwardly by the spring 333.

Since the lower end of the tapered tube 335b of the skirt portion 335a of the piston 335 fits into the middle diameter portion 331c of the cylinder 331 when the piston 335 is pushed down, the liquid L that has flown into the middle portion 331b of the cylinder 331, as a result of pushing up the metal ball 332, does not flow into the gap between piston 335 and the large diameter portion 331c of the cylinder 331, but into the skirt portion 335a and then into the pipe portion 335d of the piston 335.

The liquid L flows through the pipe portion 335d of the piston 335 and then into the liquid passage 343. Since the portion of the liquid passage 343 near the outlet is the tapered tube 343c that becomes narrower toward the outlet, the pressure of the liquid flowing therethrough increases along the tapered tube 343c. When the liquid of high pressure is discharged from the outlet, it spreads out in the form of a mist.

As described above, the spray 1 according to the invention is configured such that the liquid L of the bottle 200 is sprayed after it had passed through the spray cartridge 310 filled with the filler M.

Hereinafter, the number of negative ions measured in the atmosphere into which the liquid is sprayed by the spray 1 shown in FIG. 1 will be described. The number of negative ions measured in the atmosphere into which the liquid is sprayed by the spray 1 which is not provided with the filter cartridge 310, that is, the small diameter portion 331a of the cylinder 331 and the liquid introducing tube 321 are directly connected in a leakproof manner by the connection tube 322, will also be described for comparison.

The measurement of the number of ions is performed with an ion-counter SC-50 available from Sigmatec Inc. The measurement is carried out by locating the spray at a distance of 30 cm from the ion-counter, directing the tapered tube 343c of the spray nozzle 340 toward the sensor of the ion-counter, and then spraying the liquid L one time (the amount of liquid being sprayed is 0.2 g). The air around the spray 1 is absorbed at a rate of 60 l/min toward the sensor of the ion-counter by a blower provided to the backside of the ion-counter. The temperature and the relative humidity at the time of measurement was 20° C. and 54%, respectively. The numbers of ions measured as above are shown in Table 1. The results shown are the average of three measurements.

TABLE 1

| Used spray | Number of counts of negative ions |
|---|---|
| Spray with the filter | 23857 counts/cm³ |
| cartridge | |
| Spray without the filter | 1042 counts/cm³ |
| cartridge | |

As shown in table 1, the spray according to the present embodiment, i.e., the spray provided with the filter cartridge filled with filler M, is capable of generating negative ions in the atmosphere more than 20 times of that generated by the spray without the filter cartridge 310.

It should be noted that though comminuted Tourmaline is used as filler M in the present invention, other materials may also be used as the filler if the liquid sprayed after having passed by such materials ionizes the ambient atmosphere negatively. Examples of such materials include materials bearing electrical charges such as Tourmaline ore and ceramics including Tourmaline ore, materials that radiate far infrared radiation, and materials that radiate minute quantities of radioactive rays.

Materials that efficiently radiate far infrared rays include Maifan stone, Serpentine stone, charcoal, and ceramics containing one or more of these materials. Materials radiating minute quantities of radioactive rays include radium-containing ore and ceramics containing it.

The filler M of the spray 1 according to the present embodiment is exchangeable. The filter cartridge 310 can be detached from the spray 1 by pulling out the small diameter portion 331a of the cylinder 331 from the small diameter cylindrical portion 312b of the cartridge cap 312, and also pulling out the small diameter cylindrical portion 311a of the cartridge body 311 from the connection tube 322. After the old filter cartridge 310 is brought out from the spray 1, a new filter cartridge 310 may be connected between the small diameter portion 331a of the cylinder 331 and the connection tube 322 to exchange the filler M.

Although the spray 1 according to the embodiment is configured such that the filler M is exchanged by exchanging the whole filter cartridge 310, the invention is not limited to such configuration. The filter body 311 alone may be exchanged by disconnecting it from the cartridge cap 312. The filter body 311, or the filler M, may also be exchanged by exchanging the whole spray head 300.

Although the filter cartridge 310 is provided between the liquid introducing tube 321 and the cylinder 331 in the embodiment described above, the filter cartridge 310 may be provided anywhere of the conduit formed between the liquid introducing tube 321 and the cylinder 331 and through which the liquid L flows.

It should be noted that the dimension of the conduit and/or the filter cartridge 310 and the type of the filler M as well as the particle size thereof may be determined based on the amount of liquid to be sprayed.

The spray according to the embodiment has a simple structure and an improved portability since it does not includes high voltage components such as the electrodes of the negative ion generators. Thus, the invention is applicable not only to sprays for spraying water, but also to sprays for spraying various kinds of liquid of which solvent is water. Such sprays include, for example, sprays for a humidifier, sprays for spraying face lotion, and sprays for spraying a water-soluble perfume.

Further, although a spray having a specific structure is described as an exemplary embodiment of the invention, it should be understood that the invention is not limited to that specific structure. A sprays having other structures than that of the embodiment can achieve the same effect if a cartridge filled with the filler M is provided to the conduit that leads the liquid from the bottle to the spray nozzle.

1. A spay for spraying liquid in an atmosphere, comprising:
a spray nozzle that sprays the liquid in the form of a mist;
a bottle filled with the liquid; and
a conduit through which the liquid flows from said bottle to said spray nozzle,
wherein a specific material is provided at least at a part of said conduit so that ambient atmosphere is ionized negatively as the liquid passed by said specific material is sprayed from said spray nozzle.

2. The spray according to claim 1, wherein said specific material is held in a material holder which is provided at least at a part of said conduit.

3. The spray according to claim 2, wherein said material holder is a cartridge provided at a midway of said conduit and has a hollow portion in which said specific material is held.

4. The spray according to claim 3, wherein said cartridge is detachably coupled to said conduit.

5. The spray according to claim 3, wherein said material is accommodated in said specific material holder as being comminuted.

6. The spray according to claim 5, wherein said comminuted specific materials have sizes ranging from 0.1 mm to 5 mm.

7. The spray according to claim 6, wherein said comminuted specific material have sizes ranging from 0.5 mm to 1 mm.

8. The spray according to claim 5, comprising a first filter provided at least on a downstream side of said cartridge to prevent said comminuted specific material from moving into said spray nozzle.

9. The spray according to claim 8, wherein said first filter is a sponge made of polyethylene.

10. The spray according to claim 8, comprising a second filter provided on an upstream side of said cartridge to prevent said comminuted specific material from flowing back into said bottle.

11. The spray according to claim 10, wherein said second filter is a sponge made of polyethylene.

12. The spray according to claim 1, wherein said specific material charges ambient materials by the effect of temperature and/or pressure variations.

13. The spray according to claim 12, wherein said ambient materials include water.

14. The spray according to claim 12, wherein said ambient materials include small particles in the air.

15. The spray according to claim 12, wherein said specific material is Tourmaline.

16. The spray according to claim 12, wherein said specific material is ceramics containing Tourmaline ore.

17. The spray according to claim 1, wherein said specific material emits far infrared radiation at ordinary temperature.

18. The spray according to claim 17, wherein said specific material is charcoal.

19. The spray according to claim 17, wherein said specific material is Maifan stone.

20. The spray according to claim 17, wherein said specific material is Serpentine stone.

21. The spray according to claim 17, wherein said specific material is ceramics containing one or more of charcoal, Maifan stone, and Serpentine stone.

22. The spray according to claim 1, wherein said specific material emits minute quantities of radioactive rays.

23. The spray according to claim 22, wherein said specific material is radium-containing ore.

24. The spray according to claim 22, wherein said specific material is ceramics including radium-containing ore.

25. The spray according to claim 1, wherein said spray is a pump spray.

26. A cartridge for a spray which sprays liquid contained in a bottle into an atmosphere through a spray nozzle, said cartridge having a hollow portion provided at least at a part of a conduit through which the liquid is fed to said spray nozzle, wherein said cartridge is filled with a specific material, and wherein said atmosphere is negatively ionized when the liquid is sprayed from said spray nozzle after passing by said specific material.
